(19) United States
(12) Patent Application Publication
(10) Pub. No.: US 2024/0316995 A1
(43) Pub. Date: Sep. 26, 2024

(54) Module in expanded elastomeric material for filling a tire of a cycle or motorcycle

(71) Applicant: MRWOLF S.r.l., Brescia (IT)

(72) Inventor: Tiziano Internò, Brescia (IT)

(21) Appl. No.: 18/269,976

(22) PCT Filed: Dec. 29, 2021
(86) PCT No.: PCT/IB2021/062419

§ 371 Date: Jun. 28, 2023

(30) Foreign Application Priority Data
Dec. 29, 2020 (IT) 102020000032705

(51) Int. Cl. B60C 17/06; B60C 7/10; B60C 7/12

(52) U.S. Cl. CPC B60C 17/06; B60C 7/1015; B60C 7/125; B60C 2017/063; B60C 2200/10; B60C 2200/14

(57) ABSTRACT

A module, usable with a plurality of other modules, to obtain an annular modular assembly adapted to fill a tire of a cycle or motorcycle. The module can be removably inserted into the tire and includes a body made of foamed elastomeric material defining a portion of the annular modular assembly. The body has a shape of circular or ellipsoidal section with tapered end areas designed, in use, to remain facing or in contact with one of the tapered end areas of the adjacent modules. The tapered end areas define respective planes converging toward the center of the tire and angularly spaced by an angle between 8° and 30°.

### TECHNICAL FIELD

The present invention generally relates to the technical field of accessories for cycles and motorcycles, and it particularly relates to a module for filling a tyre of a cycle or motorcycle.

The invention also relates to the use of a plurality of such modules for filling a tyre of a cycle or motorcycle, a kit and a wheel which include such modules.

### STATE OF THE ART

It is known that in motorcycling or cycling sports, both competitive and amateur, on rough or in any case non-asphalted terrains it is advisable to fill the inside of the tyres of the cycle or motorcycle using a filling element.

This increases the protection of the tyre against punctures and pinching compared, for example, to conventional air chambers. On the other hand, the filling element enhances the performance of the tyre in terms of damping against impacts, raises the grip of the tyre on different types of terrain and, more generally, it improves the comfort and riding feeling for the rider.

Various types of filling elements are available on the market. In particular, a toroidal ring made of foamed elastomeric material, for example butyl or EVA, which fills the entire section of the tyre is known.

The main drawbacks of this known filling element are the complex assembly in the tyre, a poor versatility of use and a limited duration over time.

Furthermore, this known filling element is expensive in case of damage or breakage.

### SUMMARY OF THE INVENTION

An object of the present invention is to at least partly overcome the drawbacks illustrated above by providing a module for filling a tyre of a cycle or motorcycle that is highly efficient and cost-effective.

Another object of the present invention is to provide a filling module which that is easy and quick to fit into the tyre of any cycle or motorcycle.

Another object of the present invention is to provide a filling module which allows to adapt the elastic response of the tyre of a cycle or motorcycle depending on the needs of the user.

Another object of the present invention is to provide a long-life module for filling a tyre of a cycle or motorcycle.

Another object of the present invention is to provide a module for filling a tyre of a cycle or motorcycle which is highly versatile in terms of adaptability to different types of tyres and/or rims.

These and other objects which will be more apparent hereinafter, are attained by a module for filling a tyre of a cycle or motorcycle and/or by the relative use for filling a tyre of a cycle or motorcycle and/or by a kit and/or a wheel as described, illustrated and/or claimed herein.

The dependent claims define advantageous embodiments of the invention.

### BRIEF DESCRIPTION OF THE DRAWINGS

Further characteristics and advantages of the invention will be more apparent in light of the detailed description of a preferred but non-exclusive embodiment of the invention, illustrated by way of non-limiting example with reference to the attached drawings, wherein:

FIG. 1 is an axonometric view of a first embodiment of annular modular assembly 1 for filling the tyre of a cycle or motorcycle, wherein the modules 2 are in contact with each other;

FIGS. 2 and 3 are respectively front and lateral views of the annular modular assembly 1 of FIG. 1;

FIG. 4 is a front view of another embodiment of an annular modular assembly 1 for filling the tyre of a cycle or motorcycle, in which the modules 2 are separated from each other;

FIGS. 5, 6 and 7 are respectively axonometric, front and lateral views of an embodiment of a module 2;

FIG. 8 is a front view of another embodiment of a module 2;

FIG. 9 is a front view of a further embodiment of a module 2.

### DETAILED DESCRIPTION OF SOME PREFERRED EMBODIMENTS

With reference to the attached figures, herein described is an annular modular assembly 1 suitable for filling a tyre of a cycle or motorcycle, for example a mountain bike or a motocross motorcycle.

In a per se known manner, the tyre is mounted on the rim of a wheel of the cycle or motorcycle. Given that it is per se known, the tyre and the rim of the cycle or motorcycle were not shown in the attached drawings.

By way of non-limiting example, the present invention may be particularly useful for cycling or motorcycling sports activity on rough terrain, for example mountain bike or motocross. On the other hand, it is clear that the present invention may be used in any situation wherein the cyclist or motorcyclist deems it appropriate to use it, without particular limitation.

However, by its nature, the use of the present invention is limited to cycling, motorcycling or applications in which the stresses on the tyre are substantially similar. Therefore, it is clear that the present invention cannot be used for filling the tyre of a motor vehicle, a tractor or similar vehicle.

The annular modular assembly 1 consists of a plurality of modules 2 to be removably inserted into the tyre arranged side by side, so as to cover the entire circumferential extension of the tyre.

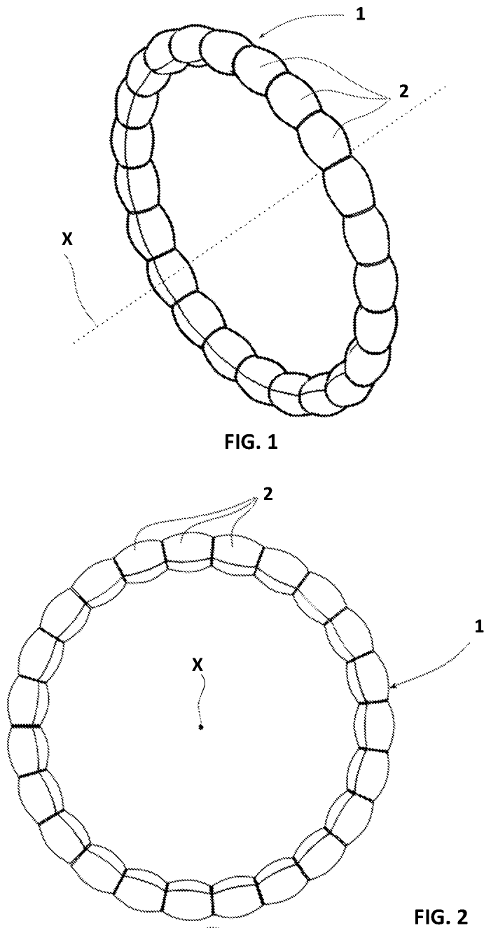

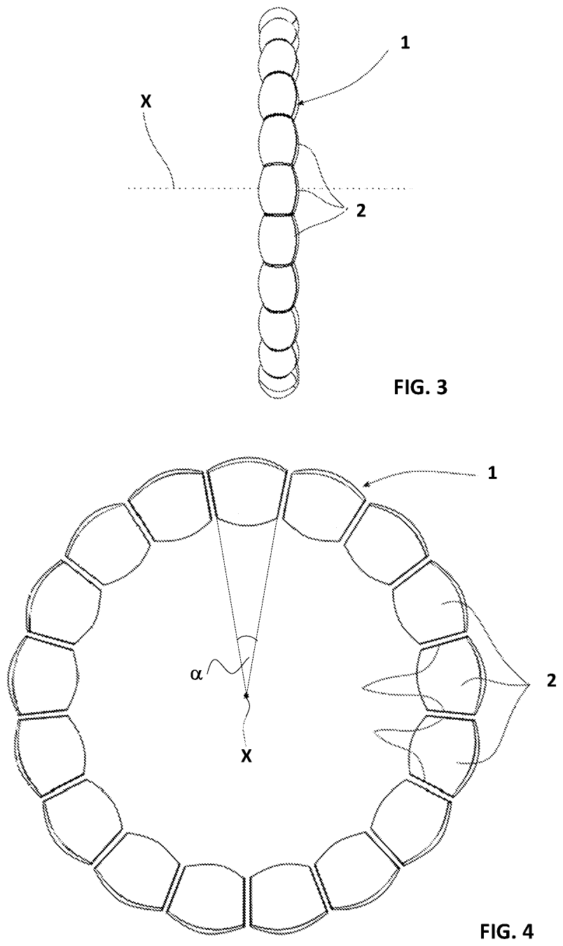

More particularly, once inserted into the tyre, the modules 2 may be in contact with each other, for example as illustrated in FIGS. 1-3, or spaced from each other, for example as illustrated in FIG. 4, for example a distance of 1 mm-10 mm. It is clear that FIG. 4 shows an embodiment of the annular modular assembly 1 which includes a number of modules 2 smaller than that of FIGS. 1-3.

However, even when they are spaced apart, when using the cycle or motorcycle the modules 2 will tend to deform under load, due to the stresses to which they are subjected and the resulting thermal expansion, therefore they can in any case come into mutual contact.

Basically, each module 2 of the annular modular assembly 1 will define a portion or section of the latter and it may consist of a body made of foamed elastomeric material, preferably with closed cells, for example butyl rubber or EVA. As known, the foamed elastomeric material is highly compressible and elastic, so as to absorb impacts and deformations in an optimum manner.

By way of example, the foamed elastomeric material may have a density comprised between 0.05 gr/cm³ and 0.8 gr/cm³, measured according to the ASTM D297 standard, or a density comprised between 0.05 gr/cm³ and 1 gr/cm³, for example measured according to the ISO 845 standard.

A possible composition of the material may be:
1 basic elastomer: 30%-70% by weight;
black fillers: 10%-30% by weight;
white fillers: 0%-10% by weight;
plasticisers: 2%-20% by weight;
foaming agents (chemical and/or physical): 3%-10% by weight.

All the aforementioned components may be of the type per se known to the person skilled in the art.

For example, the basic elastomer may be IIR, BIIR or CIIR. The black fillers may optionally consist of carbon black, whereas the white ones, which may be reinforcing and non-reinforcing, may for example be silica and/or kaolin.

The modules 2 can be made by vulcanisation, for example with sulphur or peroxide.

The configuration of the modules 2 may be such that once inserted into the tyre, the entire internal volume of the latter may be filled, without any empty spaces.

Although the present description describes modules 2 entirely consisting of a body made of foamed elastomeric material, it is clear that the modules 2 may optionally include a central main body as described above and one or more surface covering layers, for example, one or more anti-friction layers or acting as a barrier against the leakage of gases, without departing from the scope of protection of the attached claims.

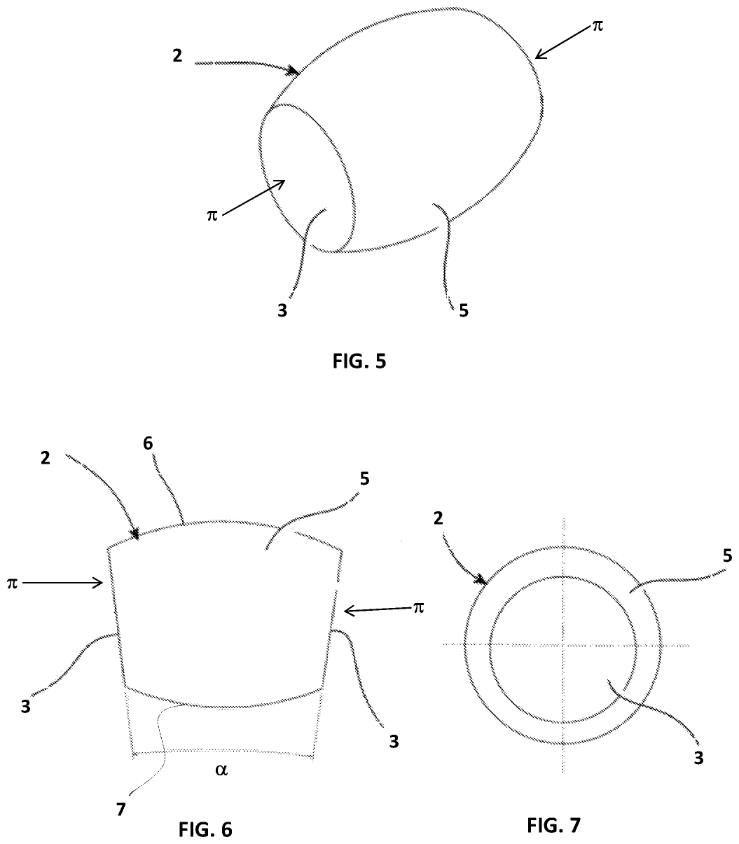

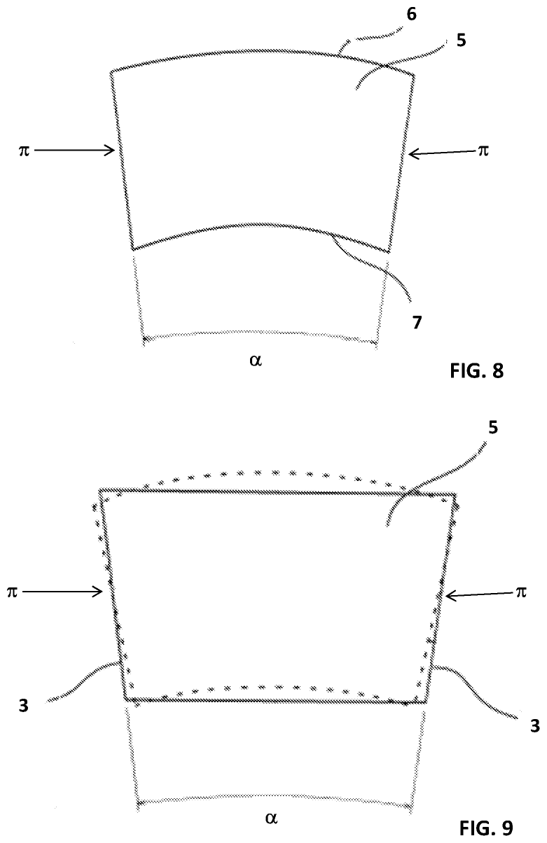

Advantageously, each module 2 may have the circular-section shape, for example as illustrated in FIG. 8, or ellipse-shaped, for example as illustrated in FIGS. 1-7, with tapered end areas 3 preferably flat or slightly dome-shaped designed, as mentioned above, to remain facing or in contact with the corresponding tapered end areas 3 of the adjacent modules once inserted into the tyre to form the annular modular assembly 1.

Advantageously, the end areas 3 may have a circular or elliptical cross-section, so as to optimally adhere to the corresponding end areas of the adjacent modules 2.

Each module 2 may also have a lateral surface 5 interposed between the tapered end areas 3 designed for use to come into contact with the tyre and with the tyre and with the rim of the wheel on which the latter is mounted.

More particularly, the lateral surface 5 may have a first portion 6 designed to come into contact with the inside of the tyre and a second portion 7 designed to come into contact with the rim of the wheel.

On the other hand, for example as illustrated in FIG. 9, the modules 2 may also have an elongated cylindrical or ellipsoidal shape. As a matter fact, thanks to the elasticity of the foamed elastomeric material, they may take the shape of a circular or ellipsoidal section, that is they may take a curved shape, once inserted into the tyre and elastically forced thereinto, as schematically illustrated in FIG. 9 where the solid line indicates the shape that the module 2 takes in the absence of stresses and the dashed line indicates the shape that the module 2 takes when elastically forced into the tyre.

In any case, the tapered end areas 3 may define respective planes π incident with respect to each other and angularly spaced by an angle α comprised between 8° and 30°, preferably comprised between 10° and 25°, and even more preferably comprised between 12° and 22°.

Thanks to this characteristic, the number of modules 2 for covering the entire circumferential extension of the annular modular assembly 1 may be sufficiently high to allow the user to customise the elastic response of the tyre whenever required.

The number of modules 2 sufficient to cover the entire circumferential extension of the tyre will vary depending on the size of the latter, without prejudice to the angular extension indicated above. Furthermore, the number and size of the modules may vary depending on whether the modules themselves are intended to fill the front or rear wheel.

Furthermore, the compressibility of the foamed elastomeric material allows to insert—into the tyre—a number of modules 2 greater than those required to cover the entire circumferential extension of the annular modular assembly 1.

This will allow to stiffen the tyre, given that the modules 2 inside the tyre are pre-loaded. On the other hand, the use of a smaller number of modules 2 than those required to cover the entire circumferential extension of the annular modular assembly 1 will render the response of the tyre to the stresses of greater comfort for the rider.

For this reason, a kit for filling a given tyre may include a packaging and a number of modules 2 preferably greater than those required to cover the entire circumferential extension of the same tyre.

This allows a user to customise the elastic response of the tyre to the maximum, given that the user may insert a number of modules greater or smaller than those required to cover the entire circumferential extension of the tyre.

By way of non-limiting example for example if 24 circular-section shaped modules (FIG. 8), 15° each, are required to cover the entire circumferential extension of a front tyre of a motorcycle, the kit may contain 25, 26 or more modules.

By way of example, each module can have a weight of 25 g-40 g, a length of the external cord measuring 70 mm-90 mm and a diameter measuring 60 mm-80 mm.

On the other hand, for example if 20 modules, 18° each are required to cover the entire circumferential extension of a rear tyre of a motorcycle, the kit may contain 21, 22 or more modules.

Still by way of example, each module may have a weight of 60 g-90 g, an external cord length measuring 80 mm-100 mm and a diameter measuring 80 mm-120 mm.

The compressibility of the material may be different for the modules 2 designed for the rear or front wheel.

Given the small size, the modules 2 are very simple to manufacture with respect to the toroidal filling elements of the state of the art, and very simple to fit and remove for the user or operator.

Furthermore, still with respect to the known toroidal filling elements, the modules 2 have a longer life over time and better performance because they tend to overheat less during use thanks to the greater overall surface extension considering the same volume.

Furthermore, with respect to known toroidal filling elements, the present invention is particularly cost-effective in the event of damage or breakage, because in this case it is possible to change the one or more damaged or broken modules and it is not necessary to change the whole filling element.

Suitably, before inserting into the tyre, a lubricating gel, for example of the silicone type, may be applied to the modules 2. Besides facilitating the operation of insertion into the tyre, this gel increases the heat dissipation of the modules 2 and it acts as a barrier against the leakage of the gases therefrom, increasing the duration thereof over time.

In the light of the above, it is clear that the invention attains the pre-set objectives.

The present invention may include various parts and/or similar or identical elements. Unless otherwise specified, similar or identical parts and/or elements will be indicated by a single reference numeral, it being understood that the technical characteristics described are common to all similar or identical parts and/or elements.

The invention is susceptible of numerous modifications and changes, all falling within the scope of the attached claims. All the details may be replaced with other technically equivalent elements, and the materials may be different depending on the needs, without departing from the scope of protection of the invention defined by the attached claims.

1.-19. (canceled)

20. An annular modular assembly adapted to fill a tire of a cycle or motorcycle, the tire including a carcass and being designed to be mounted on a rim of a wheel, the annular modular assembly comprising:
a plurality of identical modules, each module being removably insertable in the tire and having a body made of a compressible foamed elastomeric material,
wherein the body defines a portion of the annular modular assembly having:
tapered end areas defining respective planes configured, in use, to remain in contact with a tapered end area of an adjacent module, and
a lateral surface interposed between the tapered end areas and configured, in use, to come into contact with the tire and with the rim on which the tire is mounted,
wherein a number of the modules of the annular modular assembly is greater than a number of the modules required to cover an entire circumferential extension of the annular modular assembly of equal diameter with the modules in uncompressed state, so that the modules are mutually pre-compressed within the carcass of the tire, and
wherein:
the body has a curved shape with a circular or ellipsoidal section, the respective planes being mutually incident and angularly spaced with respect to each other by an angle comprised between 8° and 30°, or, alternatively,
the body has an elongated cylindrical or ellipsoidal shape configured to conform to a shape of the tire when the module is inserted thereinto to have a circular or ellipsoidal section with the respective planes mutually incident and angularly spaced with respect to each other by an angle comprised between 8° and 30°.

21. The annular modular assembly according to claim 20, wherein the angle is comprised between 10° and 25.

22. The annular modular assembly according to claim 20, wherein the tapered end areas have a substantially flat end face.

23. The annular modular assembly according to claim 20, wherein the foamed elastomeric material is butyl rubber or EVA.

24. The annular modular assembly according to claim 20, wherein the foamed elastomeric material is of a closed cell type.

25. The annular modular assembly according to claim 20, wherein the foamed elastomeric material has a density comprised between 0.05 g/cm³ to 0.8 g/cm³ measured according to ASTM D297 standard.

26. The annular modular assembly according to claim 20, wherein the foamed elastomeric material has a density comprised between 0.05 g/cm³ and 1 g/cm³ measured according to ISO 845 standard.

27. The annular modular assembly according to claim 20, wherein the lateral surface has a first portion configured to come into contact with an inside of the tire and a second portion configured to come into contact with the rim.

28. A method of use of an annular modular assembly for filling a tire of a cycle or motorcycle, comprising:
providing the annular modular assembly according to claim 20; and
inserting the annular modular assembly into the tire,
wherein the number of the modules inserted into the tire is larger than the number of the modules required to cover the entire circumferential extension of the annular modular assembly of equal diameter with the modules in uncompressed state, so that the modules are mutually pre-compressed within the carcass of the tire.

29. The method according to claim 28, further comprising a step of applying a lubricant to each module before the step of inserting.

30. A kit for filling a tire of a cycle or motorcycle comprising:
an annular modular assembly according to claim 20; and
a packaging configured for packaging the annular modular assembly,
wherein the number of the modules is larger than the number of the modules required to cover the entire circumferential extension of the annular modular assembly of equal diameter with the modules in uncompressed state, so that the modules are mutually pre-compressed within the carcass of the tire.

31. The kit according to claim 30, further comprising lubricating means which can be applied to the modules.
